(19) United States
(12) Patent Application Publication
(10) Pub. No.: US 2023/0077153 A1
(43) Pub. Date: Mar. 9, 2023

(54) EMITTER LOCALIZATION WITH A SINGLE RECEIVER

(71) Applicant: Wichita State University, Wichita, KS (US)

(72) Inventors: Hyuck M. Kwon, Wichita, KS (US); Ian Ellis L. Hulede, Wichita, KS (US); Andrew Rankin, Wichita, KS (US)

(21) Appl. No.: 17/820,710

(22) Filed: Aug. 18, 2022

Related U.S. Application Data
(60) Provisional application No. 63/371,645, filed on Aug. 17, 2022.
(60) Provisional application No. 63/234,439, filed on Aug. 18, 2021.

(51) Int. Cl. G01S 13/42; G01S 13/88

(52) U.S. Cl. CPC G01S 13/42; G01S 13/88

(57) ABSTRACT

In a system for determining a location of an emitter, a mobile frame is configured for movement relative to the emitter. A main receiver and a frequency mixing antenna are supported on the mobile frame at different locations on the frame but so that both move with the frame relative to the emitter. The frequency mixing antenna is configured to receive an emitter signal and output a frequency-mixed signal. The main receiver is configured to directly receive the emitter signal and receive the frequency-mixed signal. A processor is configured to determine a first Doppler frequency from the direct emitter signal and a second Doppler frequency from the frequency-mixed signal and to determine the location of the emitter in a defined search area based on the first and second Doppler frequencies. Multiple Doppler frequencies can be created also using multiple frequency mixing antennas to improve the localization resolution.

### CROSS-REFERENCE TO RELATED APPLICATION

This application claims priority to U.S. Provisional Patent Application No. 63/234,439, filed Aug. 18, 2021, and to 63/371,645, filed Aug. 17, 2022 each of which is hereby incorporated by reference in its entirety.

### STATEMENT REGARDING FEDERALLY SPONSORED RESEARCH OR DEVELOPMENT

This invention was made with government support under Grant Nos. FA9453-21-2-0011, FA9453-19-2-0003, and FA9453-21-0565 awarded by the Air Force Research Laboratory. The government of the United States has certain rights in the invention.

### FIELD

This disclosure generally pertains to a method of determining the location of an emitter using a single receiver unit.

### BACKGROUND

The following references are to various papers describing localization methods and related methodologies. Throughout this disclosure, these references are cited using an abbreviated form the citation including square brackets and the bracketed one-digit or two-digit number preceding the full citation in the list below. E.g., in this disclosure ‘[4]’ is a citation to E. Xu, Z. Ding, and S. Dasgupta, “Reduced Complexity Semidefinite Relaxation Algorithms for Source Localization Based on Time Difference of Arrival,” IEEE Transactions on Mobile Computing, vol. 10, no. 9, pp. 1276-1282, 2010.
[1] E. Tzoreff, B. Z. Bobrovsky, and A. J. Weiss, “Single Receiver Emitter Geolocation Based on Signal Periodicity With Oscillator Instability,” IEEE Transactions on Signal Processing, vol. 62, no. 6, pp. 1377-1385, 2014.
[2] Z. Ma and K. Ho, “A Study on the Effects of Sensor Position Error and the Placement of Calibration Emitter for Source Localization,” IEEE Transactions on Wireless Communications, vol. 13, no. 10, pp. 5440-5452, 2014.
[3] K. Dogancay, “Emitter Localization Using Clustering-Based Bearing Association,” IEEE Transactions on Aerospace and Electronic Systems, vol. 41, no. 2, pp. 525-536, 2005.
[4] E. Xu, Z. Ding, and S. Dasgupta, “Reduced Complexity Semidefinite Relaxation Algorithms for Source Localization Based on Time Difference of Arrival,” IEEE Transactions on Mobile Computing, vol. 10, no. 9, pp. 1276-1282, 2010.
[5] E. Tzoreff and A. J. Weiss, “Path Design for Best Emitter Location Using Two Mobile Sensors,” IEEE Transactions on Signal Processing, vol. 65, no. 19, pp. 5249-5261, 2017.
[6] G. E. Bottomley and D. A. Cairns, “Approximate Maximum Likelihood Radio Emitter Geolocation With Time-Varying Doppler,” IEEE Transactions on Aerospace and Electronic Systems, vol. 55, no. 1, pp. 429-443, 2018.
[7] K. Ho and Y. Chan, “Solution and Performance Analysis of Geolocation by TDOA,” IEEE Transactions on Aerospace and Electronic Systems, vol. 29, no. 4, pp. 1311-1322, 1993.
[8] F. Shu, S. Yang, Y. Qin, and J. Li, “Approximate Analytic Quadratic-Optimization Solution for TDOA-Based Passive Multi-Satellite Localization With Earth Constraint,” IEEE access, vol. 4, pp. 9283-9292, 2016.
[9] S. Ting and G. Yong, “TDOA Estimation of Dual-Satellites Interference Localization Based on Blind Separation,” Journal of Systems Engineering and Electronics, vol. 30, no. 4, pp. 696-702, 2019.
[10] A. Haniz, G. K. Tran, K. Saito, K. Sakaguchi, J.-i. Takada, D. Hayashi, T. Yamaguchi, and S. Arata, “A Novel Phase-Difference Fingerprinting Technique for Localization of Unknown Emitters,” IEEE Transactions on Vehicular Technology, vol. 66, no. 9, pp. 8445-8457, 2017.
[11] K. Dogancay, “Bearings-Only Target Localization Using Total Least Squares,” Signal processing, vol. 85, no. 9, pp. 1695-1710, 2005.
[12] M. Chen, X. Mao, X. Long, and L. Xin, “Underdetermined Direct Localization of Emitters Based on Spatio-Temporal Processing,” IEEE Signal Processing Letters, vol. 25, no. 3, pp. 452-456, 2018.
[13] M. Chen, X. Mao, and C. Zhao, “Direct Localization of Emitters Based on Sparse Bayesian Learning,” IEEE Transactions on Vehicular Technology, vol. 68, no. 6, pp. 5769-5781, 2019.
[14] Z. Shen, J. Li, and Q. Wu, “Data-Driven Interference Localization Using a Single Satellite Based on Received Signal Strength,” IEEE Transactions on Vehicular Technology, vol. 69, no. 8, pp. 8657-8669, 2020.
[15] J. Yuan, E. De Carvalho, R. J. Williams, E. Bjornson, and P. Popovski, “Frequency-Mixing Intelligent Reflecting Surfaces for Nonlinear Wireless Propagation,” IEEE Wireless Communications Letters, vol. 10, no. 8, pp. 1672-1676, 2021.
[16] Z. Chu, W. Hao, P. Xiao, and J. Shi, “Intelligent Reflecting Surface Aided Multi-Antenna Secure Transmission,” IEEE Wireless Communications Letters, vol. 9, no. 1, pp. 108-112, 2019.
[17] D. Ramaccia, D. L. Sounas, A. Alù, A. Toscano, and F. Bilotti, “Phase-Induced Frequency Conversion and Doppler Effect With Time-Modulated Metasurfaces,” IEEE Transactions on Antennas and Propagation, vol. 68, no. 3, pp. 1607-1617, 2019.
[18] T. L. Jensen and E. De Carvalho, “An Optimal Channel Estimation Scheme for Intelligent Reflecting Surfaces Based on a Minimum Variance Unbiased Estimator,” in ICASSP 2020-2020 IEEE International Conference on Acoustics, Speech and Signal Processing (ICASSP). IEEE, 2020, pp. 5000-5004.
[19] M. Di Renzo, A. Zappone, M. Debbah, M.-S. Alouini, C. Yuen, J. De Rosny, and S. Tretyakov, “Smart Radio Environments Empowered by Reconfigurable Intelligent Surfaces: How It Works, State of Research, and The Road Ahead,” IEEE Journal on Selected Areas in Communications, vol. 38, no. 11, pp. 2450-2525, 2020.
[20] S. Hong, C. Pan, H. Ren, K. Wang, K. K. Chai, and A. Nallanathan, “Robust Transmission Design for Intelligent Reflecting Surface-Aided Secure Communication Systems With Imperfect Cascaded CSI,” IEEE Transactions on Wireless Communications, vol. 20, no. 4, pp. 2487-2501, 2020.
[21] A. Mukherjee, V. Kumar, and L.-N. Tran, “Secrecy Rate Maximization for Intelligent Reflecting Surface Assisted MIMOME Wiretap Channels,” arXiv preprint arXiv: 2108.10688, 2021.
[22] M. Cui, G. Zhang, and R. Zhang, “Secure Wireless Communication via Intelligent Reflecting Surface,” IEEE Wireless Communications Letters, vol. 8, no. 5, pp. 1410-1414, 2019.
[23] H. Shen, W. Xu, S. Gong, Z. He, and C. Zhao, “Secrecy Rate Maximization for Intelligent Reflecting Surface Assisted Multi-Antenna Communications,” IEEE Communications Letters, vol. 23, no. 9, pp. 1488-1492, 2019.
[24] Q. Wu and R. Zhang, “Beamforming Optimization for Wireless Network Aided by Intelligent Reflecting Surface With Discrete Phase Shifts,” IEEE Transactions on Communications, vol. 68, no. 3, pp. 1838-1851, 2019.
[25] Q. Pan, J. Wu, X. Zheng, W. Yang, and J. Li, “Differential Privacy and IRS Empowered Intelligent Energy Harvesting for 6G Internet of Things,” IEEE Internet of Things Journal, 2021.
[26] L. Dong and H.-M. Wang, “Enhancing Secure MIMO Transmission via Intelligent Reflecting Surface,” IEEE Transactions on Wireless Communications, vol. 19, no. 11, pp. 7543-7556, 2020.
[27] A. Abrardo, D. Dardari, and M. Di Renzo, “Intelligent Reflecting Surfaces: Sum-Rate Optimization Based on Statistical Position Information,” IEEE Transactions on Communications, vol. 69, no. 10, pp. 7121-7136, 2021.
[28] E. M. Taghavi, A. Alizadeh, N. Rajatheva, M. Vu, and M. Latvaaho, “User Association in Millimeter Wave Cellular Networks With Intelligent Reflecting Surfaces,” in 2021 IEEE 93rd Vehicular Technology Conference (VTC2021-Spring). IEEE, 2021, pp. 1-6.
[29] D. J. Torrieri, “Statistical Theory of Passive Location Systems,” IEEE Transactions on Aerospace and Electronic Systems, vol. 20, no. 2, pp. 183-198, 1984.
[30] A. Amar and A. J. Weiss, “Localization of Narrowband Radio Emitters Based on Doppler Frequency Shifts,” IEEE Transactions on Signal Processing, vol. 56, no. 11, pp. 5500-5508, 2008.
[31] P. Ellis, D. Van Rheeden, and F. Dowla, “Use of Doppler and Doppler Rate for RF Geolocation Using a Single LEO Satellite,” IEEE Access, vol. 8, pp. 12 907-12 920, 2020.

Emitter localization has been an area of interest in wireless communications because it is important for civil and military purposes and for detection of foreign bodies that could be jammers or unknown radio frequency (RF) signal sources. Emitter localization has been studied over the years, and various algorithms and techniques have been proposed to that effect.

For example, time of arrival (TOA), time difference of arrival (TDOA), angle of arrival (AOA), and received signal strength (RSS) methods have been studied in the literature for emitter localization. TOA-based algorithms use the propagation time of the signal from an emitter to a receiver or sensor for localization estimation. The signal is processed at different receivers, and localization is performed using the TOA measurements from these receivers. Typically, multiple receivers (RXs) are required for the TOA-based techniques. The work in [1], [2] shows algorithms based on TOA. TDOA is the difference between TOA measurements from the same emitter and the same transmission time [3]—[9].

Localization of the emitters can also be performed using angle of arrival (AOA) estimation, where several antenna arrays are used at several receivers [10], [11]. There have also been algorithms that use combinations of these methods. The work in [12] and [13] uses joint TDOA and AOA for emitter localization, and the work in [14] presents an algorithm based on RSS.

A Doppler frequency at an RX is a function of a relative velocity vector and a relative position vector between an RX and an electromagnetic interference (EMI) source transmitter (TX) or emitter. Therefore, Doppler frequency has been measured in practice. Furthermore, multiple RXs have been employed because an EMI TX position is a function of multiple variables, e.g., EMI TX position vector (x₀, y₀, z₀) and velocity (vₓ₀, v_{y0}, v_{z0}).

Most existing algorithms employ multiple RXs that measure and exchange the necessary information extracted from the received EMI source signal. A few algorithms use just one RX. References [5], [7]—[9] use more than one receiver, while [1] and [14] use just one receiver.

Investigators in the literature have assumed that RX positions of significant distances and RX velocities of significantly different directions can create more effective Doppler frequencies. For example, airplanes are flying at a minimum 9,260 meters (5 nm) apart, drones at 4.827 km (3 statute miles) apart, and satellites at 700 km altitude and 122 km apart.

The other differential Doppler (DD) method and its variants have been presented in the literature for many years. For example, in 1984, Torrieri analyzed a DD method that employs multiple physically separated RXs that intercept an EMI emitter signal at different positions and measure their respective Doppler frequencies [29]. Then, each RX sends the measured Doppler frequency information to a signal processing center RX. At each interception interval along a trajectory, the difference in frequency shifts among the multiple RXs is computed in the first step. Then, the position of the emitter is estimated based on the results of the previous step. These are the two steps involved in the DD method.

In 2008, Amar and Weiss improved upon this DD method with the direct position determination (DPD) approach [30]. This approach uses a single step without Doppler frequency measurement, whereas the DD method involves two steps: Step 1—measurement of Doppler frequency at each RX; and Step 2—measurement of the Doppler frequency differences among the RXs. In their approach, a fading coefficient, e.g., Rayleigh fading, was also considered in the RX signal at every interception interval, and an additive white Gaussian noise (AWGN) was added at each sampling time. Then, the maximum likelihood (ML) function was used as the objective cost function for a given fading coefficient. The EMI source position vector that maximizes the ML cost function among possible grid points was selected in a single step from all available intercepted data. In other words, no other steps were involved. It was shown that the DPD approach has less error than the conventional DD method at lower signal-to-noise-ratio (SNR) values. Both DD and DPD assumed at least two physically separated RXs; therefore, the RXs were positioned many kilometers apart, e.g., 10 km in [30].

Also, the DD method in [29] measures the Doppler frequencies at the multiple dislocated RXs at the same interception interval. Hence, calculating the difference between the two measured frequencies at two different RXs cancels out the unstable TX frequency component. Therefore, the Doppler frequency measured using the DD method in [29] will be free of the EMI TX frequency instability, whereas, the DPD in [30] does not measure the Doppler frequency but rather takes samples of the Doppler-shifted received signal for localization of the EMI TX.

In a recent study, an RF geolocation problem was also investigated using a single RX [31]. Doppler frequency and Doppler frequency rate were measured at different sampling times, and constrained unscented Kalman filtering (cUKF) was applied by converting almost noiseless nonlinear equations into system state vector-variable equations [31]. For example, a high SNR was assumed, e.g., 20 dB to 40 dB at the single RX, or zero AWGN was considered in the received baseband signal (equation (10) of [31]). In addition, no fading signal or EMI TX oscillator frequency drift (i.e., instability) was assumed when the Doppler frequency and Doppler rate were measured. The last assumption in [31] may prohibit the cUKF application in practice. This is because most EMI clocks have frequency instability, and the EMI TX frequency estimation has nonzero errors. Since a single RX is employed in [31], the Doppler frequencies should be measured at two contiguous sample time points and then subtracted to estimate the Doppler frequency rate. However, since most EMI TX oscillators are unstable, two different random frequencies will be added to the carrier frequency at the two contiguous interception points and then added to the true Doppler-shifted EMI carrier frequency. Hence, the Doppler frequency rate measurement will be in error when two Doppler frequencies are contaminated by the EMI TX clock's instability. Hence, the method in [31], which requires both Doppler frequency and Doppler frequency rate measurements, will fail under the TX frequency instability conditions.

Furthermore, the cUKF method in [31] requires an Earth surface constraint for convergence and accuracy. In other words, the cUKF method requires that the location of the EMI TX is restricted to the Earth's surface, whereas the proposed method in this current paper does not require such an Earth surface constraint. To reduce search time when the EMI TX location is in three-dimensional (3D) space, the arrival angle of EMI TX signal is exploited for the proposed method. In other words, the search range is restricted to a certain area instead of the entire 3D space.

In summary, the conventional DD method, e.g., in [29], requires multiple RXs and a two-step signal processing to find the location of an EMI emitter source and shows worse performance than the existing DPD method [30]. The DPD method requires only one-step processing and shows better performance than DD [30]. However, DPD requires multiple RXs separated by significant distances. The development, launching, and maintenance of multiple RXs is expensive. The cUKF in [31] considers only the known-signal case.

### SUMMARY

In one aspect, this disclosure provides an emitter localization method that uses only a single RX instead of multiple RXs to localize an EMI TX. Therefore, the proposed method can save costs significantly by a factor of the number of RXs used in traditional methods [5], [7]-[9], [29], [30].

In another aspect, this disclosure provides a random memoryless search and random memory search, which can reduce the searching time in [30] significantly, e.g., 27 times, and enhances its resolution.

In another aspect, this disclosure provides for the creation of multiple Doppler frequency effects via frequency-mixer (FMx) antennas at a single RX, even when the EMI TX uses a single carrier frequency.

In another aspect, this disclosure provides for the creation of a chirp signal at the RX to enhance the localization resolution by using multiple FMx antennas at the RX.

In another aspect, this disclosure provides an emitter localization method that applies for both narrowband and wideband EMI signals. This is because the maximum propagation delay spread between multiple RX antennas in a single RX unit can be Δd/c=3.33×10⁻⁹ seconds for Δd=1 meter separation. Hence, the bandwidth of the intercepted signal, which is the inverse of the multipath delay spread, is equal to c/Δd=3×10⁸=0.3 GHz, where c is the speed of light. In contrast, the DPD method in [30] is applicable for only narrow-band emitter signals because of the larger separation distance, e.g., c/(Δd=10 km)=30 kHz.

In another aspect, this disclosure provides an EMI TX localization method that considers fading signal and TX frequency instability, and does not assume that the RX receives a high-power line-of-sight (LOS) EMI signal with 20-40 dB SNR, contra [31].

Other aspects will be in part apparent and in part pointed out hereinafter.

### BRIEF DESCRIPTION OF THE DRAWINGS

FIG. 1 is a schematic illustration of a conventional method for EMI TX localization;

FIG. 2 is a schematic illustration similar to FIG. 1 of a method for EMI TX localization according to the present disclosure;

FIG. 3 is an implementation block and spectrum diagram corresponding to the method depicted in FIG. 2.

FIG. 4 is a schematic illustration similar to FIG. 2 but showing a method from EMI TX localization in three-dimensional space according to the present disclosure.

FIG. 5 is a three-dimensional plot of a cost function for the localization scenario in FIG. 4 where the signal is unknown, SNR is 20 dB, and RX moves along any line parallel to y-axis for any given x between Δd=1 m and 10 km and z=200 km.

FIG. 6 is a three-dimensional plot of the cost function when signal is unknown, SNR is 20 dB, and RX moves along any line parallel to x-axis for any given y between Δd=1 m and 10 km and z=200 km.

FIG. 7 is an example trace of true position search using a random memoryless search.

Corresponding parts are given corresponding reference characters throughout the drawings.

### DETAILED DESCRIPTION

This disclosure aims to challenge the assumption that RXs physically separated by a larger distance can create better Doppler frequency effects and hence higher resolution in localization estimation. This paper claims that a single RX unit with multiple physically separated RX antennas can create different Doppler frequency effects and can locate the EMI emitter effectively, even if the EMI TX uses a single carrier frequency. To achieve that effect, this paper proposes using frequency-mixing (FMx) antennas or frequency-mixing intelligent reflecting surface (FMx-IRS) antennas as they appear in [15]. These antennas can create multiple carrier frequency signals at a single receiver, even if a single carrier frequency signal is transmitted by the EMI TX. The IRS has been investigated intensively and recently as a future wireless communication technology to improve channel capacity efficiency as well as secrecy channel capacity performance in wireless communications. For example, IRS studies are featured in [15]—[28].

This disclosure assumes a stationary emitter with zero velocity in the x, y, and z directions. Only the RX is mobile. The proposed method assumes no Global Positioning System (GPS) signal. Furthermore, the proposed method assumes a Rayleigh fading channel and includes the frequency instability of the EMI TX oscillator with the following uniform random variable distribution: uniform[−100, 100][Hz]. Therefore, the proposed method is considered under more practical and severe RF environments than the cUKF in [31].

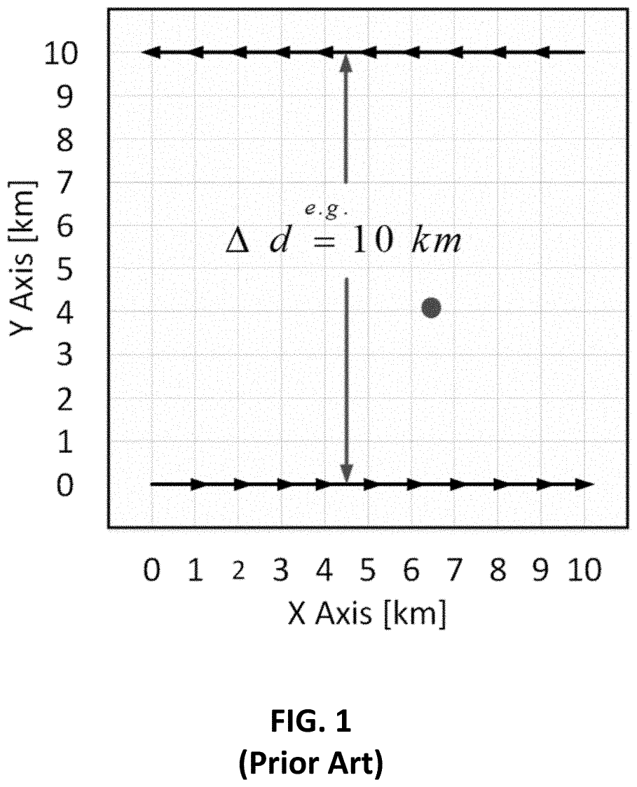

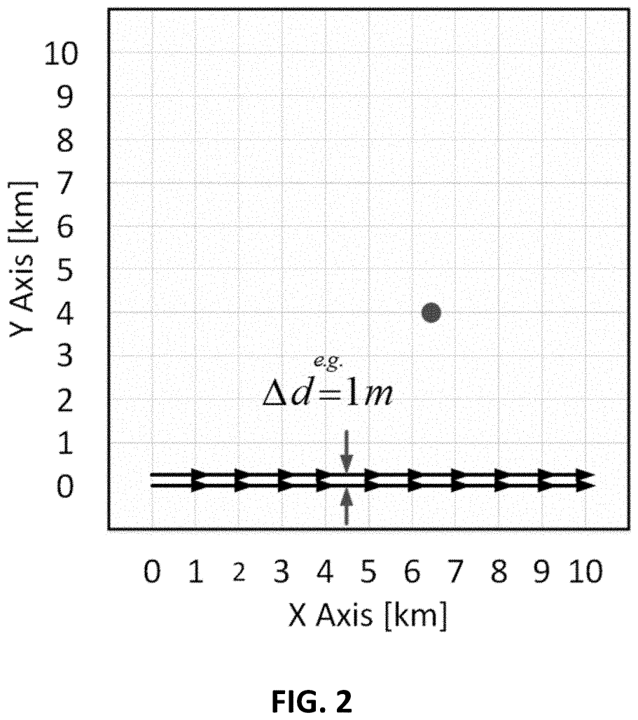

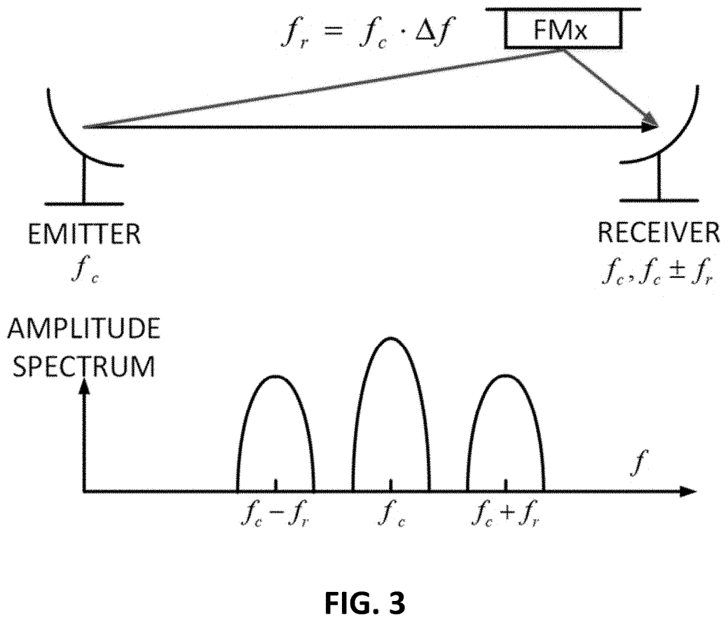

FIG. 1 shows an example scenario of the existing method in [30]. Notice that two separate RXs are moving in the opposite direction with a minimum separation distance, Δd=10 km. FIG. 2 shows an example scenario of the proposed method, and FIG. 3 shows a corresponding implementation block and spectrum diagram.

The proposed method assumes that a modulated signal of only a single carrier frequency is transmitted by the EMI TX. Then, (L−1) subcarrier frequency signals are created in addition to the received main carrier by the (L−1) FMx [15] antennas at a single RX unit (e.g., L=2) and are processed with the signal received directly from the TX to the RX. L is the total number of antennas at the RX unit, and all antennas are in proximity. The separation distances between the main RX antenna and FMx antennas are nonzero, (e.g., Δd is about 1 m or less than 10 m). Therefore, the RX antenna and (L−1) FMx antennas can be located within a single RX unit but not co-located. A massive number of antennas can be co-located for millimeter wavelength carrier frequencies in the fifth generation (5G) and future wireless communication systems. The velocity of the main RX antenna and the (L−1) FMx antennas are all equal. The objective is to localize an EMI source. The received complex equivalent lowpass signal at the lth FMx or main antenna for the kth interception interval at time t is written [30] as Equation (1) below, where Tis the observation time interval, bₗₖ, is an unknown complex scalar representing the path attenuation (e.g., Rayleigh fading) at the kth interception interval observed by the lth FMx antenna, sₖ(t), which may be known or unknown depending on the application (e.g., known for search and rescue (SAR) and unknown for an intentional EMI emitter), is the observed signal envelope during the kth interception interval, fₗₖ is the down converted frequency, and wₗₖ(t) is a complex AWGN∈CN(0, σₙ\hat{ }2), l=1, . . . , L, k=1, . . . , K.

rₗₖ(t)=bₗₖsₖ(t)e^{j2πf̅}^{ₗₖ}^{t}+wₗₖ(t), 0≤t≤T (1)

Let vₗₖ, p₀, and pₗₖ denote, respectively, the relative velocity vector between the stationary EMI TX and the mobile RX, the stationary EMI TX position vector, and the mobile lth FMx or the mobile main RX antenna position vector within a single RX at interception interval k.

The key idea of the proposed system is that the arrival frequencies at the RX are multiple frequencies, e.g., f_{c} and f_{c}+fᵣ from the direct link main antenna and the indirect link via the FMx antenna, respectively, for L=2 in FIG. 2. Note that the distance between an FMx antenna and the main RX antenna is small but nonzero e.g., with Δd=1 m. Therefore, multiple Doppler frequencies can be created at the main RX antenna, as long as Δd is non-zero. The phase differences due to the wave traveling the short distance difference can be included in the Rayleigh fading coefficient, bₗₖ(t), in Equation (1) in the analysis.

The output frequency observed by the lth receiver antenna before the down conversion during the kth interception interval is given by Equation (2):

fₗₖ=[f_{cl}+νₖ][1+μₗₖ(p₀)] (2)

where:

f_{cl}=f_{c}+(l−1)fᵣ, l=1, . . . , L (3)

f_{c} is the known transmitted signal nominal frequency, which is also the input frequency at the lth antenna, f_{cl} is the output frequency at the lth antenna, fᵣ=f_{c}Δf is the FMx frequency separation, νₖ is the unknown transmitted frequency shift due to source instability during the kth interception interval, and μₗₖ (p₀) is the Doppler frequency normalized by the carrier frequency fa and written as Equation (4):

$${μ}_{lk} ( {p}_{0} ) = \frac{1}{c} \frac{{v}_{lk}^{T} [ {p}_{0} - {p}_{lk} ]}{‖ {p}_{0} - {p}_{lk} ‖} . \qquad ( 4 )$$

The down-converted frequency fₗₖ−f_{cl} is approximated according to Equation (5) because νₖμₗₖ(p₀)<<f_{cl}. The emitter frequency instability νₖ is modeled by a uniform random variable as Equation (6) and collects N samples per interception interval T (seconds). Hence, the sampling interval is represented by Equation (7).

f̅ₗₖ≃νₖ+f_{cl}μₗₖ(p₀) (5)

νₖ=Unif[−100,100]Hz, (6)

Tₛ=T/(N−1),0≤t≤T. (7)

For RX signal processing, the same direct position determination approach in [30] can be used by changing f_{c} in [30] to f_{cl} in Equation (3) throughout. The analog RX signal in Equation (1) is sampled as rₗₖ[n]=rₗₖ(nTₛ), n={0, 1 . . . , N−1} and represented by Equation (8), where Aₗₖ is the N×N Doppler shift diagonal matrix written as Equation (9), Cₖ is an N×N emitter frequency instability diagonal matrix written as Equation (10), sₖ is the N×1 TX signal vector, and wₗₖ˜CN (0, σₙ²I_{N}) is the N×1 complex Gaussian noise vector. In Equation (9), the μₗₖ(p₀) will be replaced by μₗₖ(p) for the grid search or random search, where p is a position vector and candidate for EMI TX localization, and p₀ is the true location.

rₗₖ=bₗₖAₗₖCₖsₖ+wₗₖ (8)

Aₗₖ [symbol] diag{1,e^{j2πf}^{_{cl}}^{μ}^{ₗₖ}^{(p}^{₀}^{)T}^{ₛ}, . . . ,e^{j2πf}^{_{cl}}^{μ}^{ₗₖ}^{(p}^{₀}^{)(N-1)T}^{ₛ}} (9)

Cₖ [symbol] diag{1,e^{j2πν}^{ₖ}^{T}^{ₛ}, . . . ,e^{j2πν}^{ₖ}^{(N-1)T}^{ₛ}} (10)

The proposed algorithm maximizes the conditional likelihood function in (4) of [29] or the correlation cost function between the received vector including noise and the received vector excluding noise, given the observation vector rₗₖ. Equivalently, the proposed algorithm minimizes the exponent in the likelihood function, called the minimum distance cost function, between the received signal vector including noise and the received vector excluding noise, as done in (5) of [29], [30]:

A Minimum Distance Cost function is defined by Equation (11).

$${L}_{min distance} = \frac{1}{{σ}_{n}^{2}} {\sum }_{k = 1}^{K} {\sum }_{l = 1}^{L} {‖ {r}_{lk} - {b}_{lk} {A}_{lk} {C}_{k} {s}_{k} ‖}^{2} . \qquad ( 11 )$$

A Maximum Correlation Cost function is defined by Equation (12).

$${L}_{max correlation} = {\sum }_{k = 1}^{K} {\sum }_{l = 1}^{L} {\vert {( {A}_{lk} {C}_{k} {s}_{k} )}^{H} {r}_{lk} \vert}^{2} \qquad ( 12 )$$

Superscript H denotes the Hermitian. Equation (12) can be simplified further. The proposed algorithm will employ two simplified cost functions below from [30] for the unknown signal case and known signal case.

The objective function in Equation (12) is rewritten for the unknown signal case, and the best estimate of the EMI emitter location is found, respectively, as shown in Equations (13) and (14), where p is a possible grid point in a given search area, Vₖ and Qₖ are defined by Equations (15) and (16), and λmax(Qₖ) is the maximum eigenvalue of Qₖ, which is ≥0 since Qₖ is positive semi-definite.

$${L}_{us} ( p ) = {\sum }_{k = 1}^{K} {λ}_{max} \{ {Q}_{k} \} \qquad ( 13 )$$

$${\hat{p}}_{0} = arg {max}_{p} \{ {L}_{us} ( p ) \} , \qquad ( 14 )$$

$${V}_{k} {=}^{△} [ {A}_{1 k}^{H} {r}_{1 k} , … , {A}_{Lk}^{H} {r}_{Lk} ] , \qquad ( 15 )$$

$${Q}_{k} {=}^{△} {V}_{k}^{H} {V}_{k} , \qquad ( 16 )$$

For the known signal case, the objective function in (12) is rewritten, and the best estimate of the EMI emitter location is found, respectively, as Equations (17) or (18) and Equation (19), where cₖ is defined according to Equation (20) and Equation (21), zₖ is defined according to Equation (22), Cₖ is defined according to Equation (23), and Sₖ is defined according to Equation (24).

$${L}_{ks} ( p ) = {\sum }_{k = 1}^{K} {\sum }_{l = 1}^{L} {\vert {( {A}_{lk} {C}_{k} {s}_{k} )}^{H} {r}_{lk} \vert}^{2} \qquad ( 17 )$$

$${=}^{or} {\sum }_{k = 1}^{K} {\sum }_{l = 1}^{L} {\vert {r}_{lk}^{H} {A}_{lk} {S}_{k} {c}_{k} \vert}^{2} \qquad ( 18 )$$

$${\hat{p}}_{0} = arg {max}_{p} \{ {L}_{ks} ( p ) \} \qquad ( 19 )$$

$${c}_{k} {=}^{△} {[ 1 , {e}^{j 2 π {v}_{k} {T}_{s}} , … , {e}^{j 2 π {v}_{k} ( N - 1 ) {T}_{s}} ]}^{T} \qquad ( 20 )$$

$$= {[ 1 , {𝓏}_{k} , … , {( {𝓏}_{k} )}^{( N - 1 )} ]}^{T} , \qquad ( 21 )$$

$${𝓏}_{k} {=}^{△} {e}^{j 2 π {v}_{k} {T}_{s}} , \qquad ( 22 )$$

$${C}_{k} = diag [ {c}_{k} ] , \qquad ( 23 )$$

$${S}_{k} = diag [ {s}_{k} ] . \qquad ( 24 )$$

Sₖ and cₖ are transmitted together by the EMI. So, when Sₖcₖ in (14) is treated as known, the EMI TX unstable frequency νₖ and the transmitted sequence vector sₖ (e.g., quadrature phase shift keying (QPSK)) are known as well.

However, the known-signal case means that only the modulated symbol sequence vector sₖ in the received signal vector rₖ is known because cₖ is unintentionally transmitted by the EMI. The frequency instability νₖ in the EMI TX signal is unknown at the RX in general, and νₖ should be unknown even for the known signal case. Therefore, Lₖₛ (p) in Equation (18) should be maximized with respect to the possible grid point vector p as well as the frequency instability parameter νₖ as in Equations (25)-(27), wherein Bₖ is defined by Equation (28), Gₖ is defined by Equation (29), and αₘ is the sum of elements on the m-th diagonal of matrix Gₖ. Hence, the cost function can be rewritten as Equation (30), which finds the νₖ, for each k, that maximizes the expression for βₘ in Equation (31). Therefore, the estimated EMI position for the known signal case, excluding the frequency instability νₖ, is given by Equation (32).

$${L}_{ks} ( p ) = {\sum }_{k = 1}^{K} {\sum }_{l = 1}^{L} {\vert {r}_{lk}^{H} {A}_{lk} {S}_{k} {c}_{k} \vert}^{2} = {\sum }_{k = 1}^{K} {‖ {V}_{k}^{H} {S}_{k} {c}_{k} ‖}^{2} = {\sum }_{k = 1}^{K} {‖ {B}_{k} {c}_{k} ‖}^{2} = {\sum }_{k = 1}^{K} {( {B}_{k} {c}_{k} )}^{H} ( {B}_{k} {c}_{k} ) \qquad ( 25 )$$

$$= {\sum }_{k = 1}^{K} {c}_{k}^{H} {B}_{k}^{H} {B}_{k} {c}_{k} = {\sum }_{k = 1}^{K} {c}_{k}^{H} {G}_{k} {c}_{k} = {\sum }_{k = 1}^{K} {\sum }_{i = 0}^{N - 1} {\sum }_{j = 0}^{N - 1} {( {𝓏}_{k}^{H} )}^{i} {G}_{k} [ i , j ] {( {𝓏}_{k} )}^{j} \qquad ( 26 )$$

$$= {\sum }_{k = 1}^{K} {\sum }_{i = 0}^{N - 1} {\sum }_{j = 0}^{N - 1} {G}_{k} [ i , j ] {( {𝓏}_{k} )}^{j - i} = {\sum }_{k = 1}^{K} {\sum }_{m = - ( N - 1 )}^{N - 1} {{α}_{m} ( {𝓏}_{k} )}^{m} = {\sum }_{k = 1}^{K} Re \{ {\sum }_{m = 0}^{N - 1} {{β}_{m}^{⋆} ( {𝓏}_{k} )}^{- m} \} = {\sum }_{k = 1}^{K} Re \{ FFT \{ {β}_{m}^{⋆} \} \} \qquad ( 27 )$$

$${B}_{k} {=}^{△} {V}_{k}^{H} {S}_{k} , \qquad ( 28 )$$

$${G}_{k} {=}^{△} {B}_{k}^{H} {B}_{k} , \qquad ( 29 )$$

$${L}_{ks} ( p ) = {\sum }_{k = 1}^{K} {max}_{{v}_{k}} [ Re \{ FFT \{ {β}_{m}^{⋆} \} \} ] \qquad ( 30 )$$

$${β}_{m} {=}^{△} \{ \begin{matrix}{α}_{0} & if m = 0 \\ 2 {α}_{m} & if m = 1 , … , N - 1\end{matrix} \qquad ( 31 )$$

$${\hat{p}}_{0} = arg {max}_{p} \{ {L}_{ks} ( p ) \} . \qquad ( 32 )$$

The same notations as the ones in [30] for Equations (1) to (33) are used in this paper because they are directly applicable for the 2D system model, 2D grid search, and even for the proposed method. The next section of this disclosure describes the proposed method for a 3D grid search. Since this paper considers localization of a stationary EMI emitter, it focuses on the unknown signal case rather than the known case.

For the existing 2D grid search in [30], the z-axis altitude is set to zero, as shown in FIG. 2. The existing 2D grid search fails for a 3D grid search scenario with nonzero altitude. As the altitude increases beyond 10 km, the RMSE, e.g., 4 km, is unacceptable. In this section, the existing 2D grid search is investigated again for a 3D grid search application. Still, an EMI emitter is assumed to be stationary on the Earth's surface, and a single mobile RX unit with multiple FMx antennas is considered.

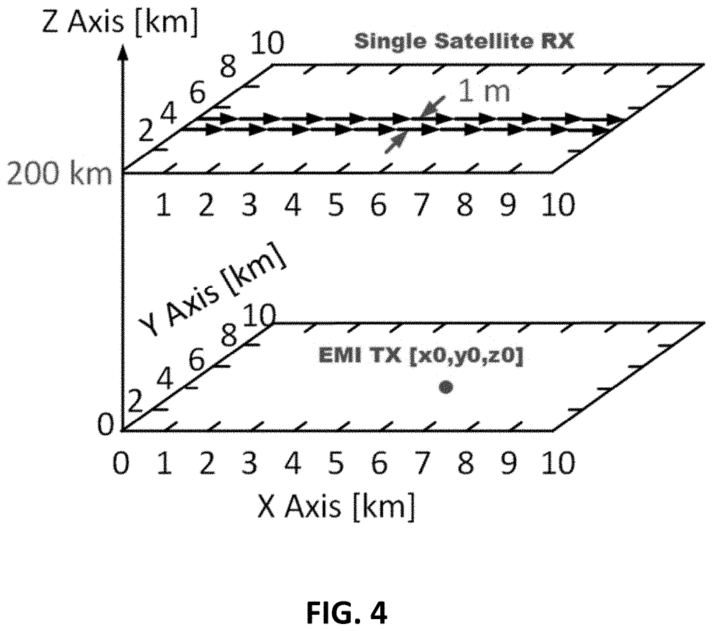

FIG. 4 shows an example scenario of a 3D grid search for the proposed method, which uses one FMx antenna and one main antenna at the receiver, i.e., L=2. Both antennas are in a single RX unit and move together with the same velocity and direction at the same altitude, e.g., z=200 km. An LEO satellite trajectory along the x-axis or y-axis is assumed without loss of generality. A stationary EMI TX source can be located anywhere on the Earth's surface, e.g., p0=[x0, y0, z0]=[6.5, 4, R_{Earth}] km, where R_{Earth}=7,361 km is the Earth's radius. The altitude z₀ in FIG. 4 was selected to be 0 km instead of the Earth's radius of 7,361 km without loss of generality. For simulation, z₀=7,361 km is used. In fact, both z₀=7,361 km and 0 km yield the same results. The altitude z₀=0 km does not represent the Earth's surface constraint required in the cUKF method [31]. In this disclosure, the altitude z₀ can be anywhere. The carrier frequency of the EMI TX source is f_{c}=0.4 GHz, representing a UHF frequency, and the main antenna of a single RX moves along the x-axis from 1 km to 10 km with p_{l=1,k}=[x_{l,k}, y_{l,k}=y, z_{l,k}=R_{Earth}+200] (km) and velocity νₗ=1=6.944 km/s, and the path of the FMx antenna is p_{l=2,k}=[x_{l,k}, y_{l,k}=y−0.001, z_{l,k}=R_{Earth}+200] (km) with the same velocity ν_{l=1=2,k}=6.944 km/s. It moves in the same x-axis direction, x_{l,k}=[1, 10] (km), with an LEO speed of ν=6.944 km/s. The y of the RX trajectory can be any number between Δd and 10 km. Here, y is set to 4 km without loss of generality. Note that the two antennas in the same RX are separated physically by only Δd=1 m on the y-axis. The EMI signal is intercepted every 1 km.

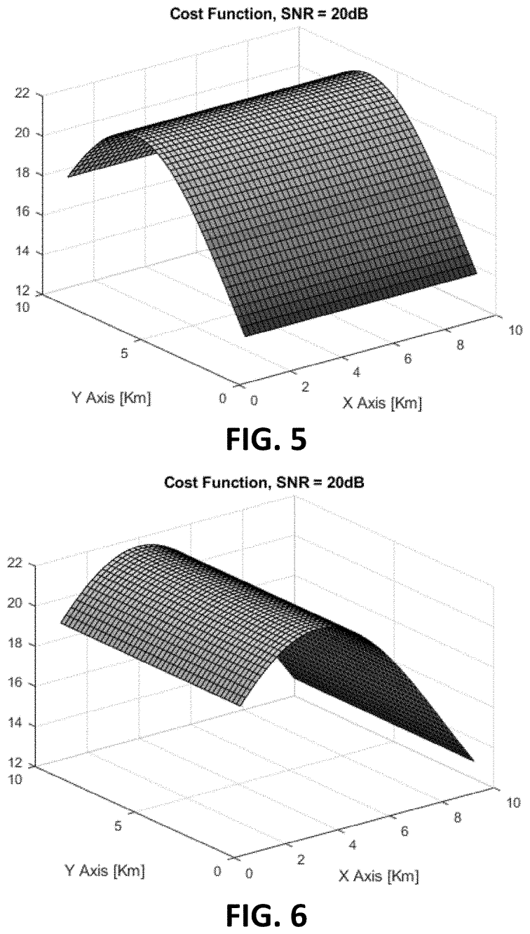

Since the altitude, 200 km, is much higher than one side of the search area, 10×10 (km×km), the cost functions will not be sensitive to the x-axis but only to the y-axis when the RX moves along a parallel line to the y-axis, and vice versa. FIGS. 5 and 6 show the cost function for the 3D search in FIG. 4, respectively, when the RX moves along a parallel line to the y-axis and x-axis. Here the signal is unknown, and the SNR is 20 dB. Observe that the 3D search cost function in FIGS. 5 and 6 show only the peak value near the true value of y₀=6.5 km and x₀=4 km, respectively, when the RX moves along a parallel line to they-axis for any given x value and a parallel line to the x-axis for any given y value in the search range. To complete the 3D search for \hat{ }p₀=[\hat{ }x₀, \hat{ }y₀], the RX must take samples moving along any parallel line to the x-axis after moving along any parallel line to the y-axis, and vice versa.

If a meter-level RMSE is desirable, then the grid size should be small, e.g., in meters because the grid search time increases exponentially. For example, if the grid size in the x-axis and y-axis, respectively, are Δdₓ=Δd_{y}=0.06 km, then the number of grid points in the x-axis and y-axis would be Nₓ=N_{y}=10 km/Δdₓ=167, and the total number of grid points would be NₓN_{y}=167\hat{ }2=27,889. At each grid point, the cost function in Equation (13) is calculated. The correlation is computed between the actual intercepted signal rₗₖ and a hypothetical received signal (AₗₖCₖsₖ) in Equation (12), which becomes Equation (13), assuming that the EMI TX is located at a hypothetical grid point, and the grid point p corresponding to the maximum correlation cost function in Equation (14) is selected. It takes 85.54 seconds for ten trials using a powerful workstation, e.g., Precision 5820 Tower. However, if Δdₓ=Δd_{y}=0.001 km, then it will take more than a month for the simulation. One trial means K=10 interceptions in FIG. 1, k=1, K. Each interception takes N=100 samples of the received signal, and L=2 RX antennas, l=1, . . . , L. This prohibits using the 2D grid search in [30] when a meter-level resolution is desirable.

To address these limitations, this disclosure contemplates two computationally efficient methods without sacrificing the RMSE performance: (a) a random memoryless search and (b) a random memory search method to reduce the grid search computation time significantly.

The QPSK symbol transmission rate is assumed to be 10 ksps. The RX does not need to have the transmitted signal information for the unknown signal case, and it takes N=100 samples of the received signal every interception interval for K=10 interception intervals and L=2 RX antennas. In the existing 2D method, the grid point vector that maximizes the cost function is selected out of N_{grid}=NₓN_{y} grid points per trial. Then, the average RMSE is computed over Nₑₓₚ=100 trials as Equation (33).

$$RMSE = \sqrt{\frac{1}{{N}_{exp}} {\sum }_{i = 1}^{{N}_{exp}} {‖ \hat{p} ( i ) - {p}_{0} ‖}^{2}} . \qquad ( 33 )$$

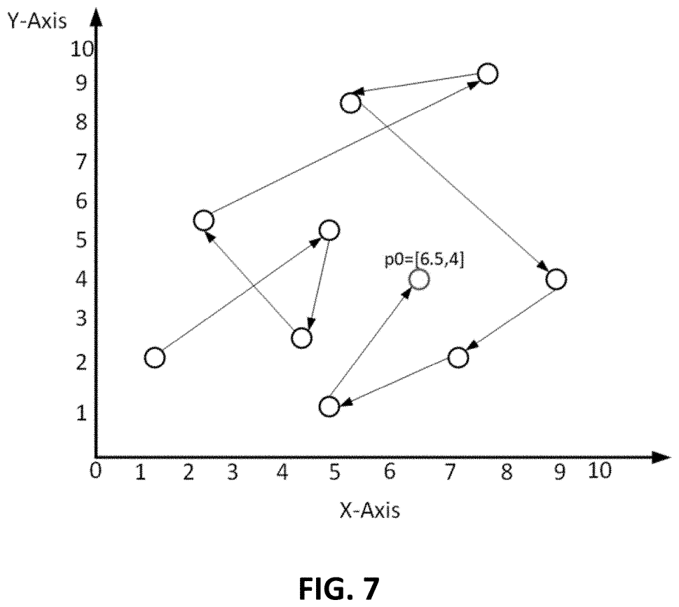

For a random memoryless search, a hypothetical position vector p is randomly generated in the specified search zone, e.g., 10×10 (km×km) in FIGS. 1, 2, and 4. Then, the cost function Lᵤₛ(p) in Equation (13) is computed with the hypothetical position vector p and the same received vector rₗₖ obtained through k=1, K=10 interceptions via l=2, . . . , L FMx antennas and the main RX antenna l=1 for the proposed on the RX unit. Then, another hypothetical position vector p is randomly generated, and a corresponding cost function is computed. The hypothetical position vector corresponding to the higher cost function is kept. This is repeated for a certain number of hypothetical position vectors until the difference in cost functions between the current and the next hypothetical position vectors are less than ϵ, e.g., 10\hat{ }−5. Then, the algorithm concludes the present trial and proceeds to the next. FIG. 7 shows an example trace of the surviving hypothetical position vectors. After a certain number of trials Nₑₓₚ, the RMSE value in Equation (33) is computed for a given Eₛ/N₀ in dB. The generated number of hypothetical position vectors is typically much smaller than the total number of grid points NₓN_{y}, in the existing grid search. Here the memoryless search means that the search in the next trial is independent of that in the current trial.

For a random memory search, the final hypothetical position vector and its corresponding cost function from the previous trial are used for the current trial (unlike a random memoryless search where a hypothetical position vector is randomly generated for every trial). Once the initial starting position vector is established, the same procedure as that of the random memoryless search is conducted for the rest of the trial. Hence, there is a memory between adjacent trials.

The complexity in a grid search will be proportional to the total number of grid points, which is the square of the number of grid points per axis in a 2D search. The complexity in the proposed random memoryless or memory search is proportional to the number of randomly generated points, which can be significantly smaller than the total number of grid points. Hence, the random search can be much faster than the grid search at the same resolution. In addition, the resolution can be improved by the random search because the step size in a grid search determines the resolution; however, there is no step size in the random search. A search point in an axis can be any real number represented by a high number of bits.

An example Random Memory Search Algorithm can be conducted in the following steps:

STEP 0: Define all parameters, e.g., total number of trials=iₜₒₜₐₗ=10.

STEP 1: Trial i=1.

STEP 2: For each SNR value and each trial value, set the cost function Lᵤₛ(p)ᵢₙᵢₜ to zero. For each SNR value and each trial value, generate the signal sₖ(t), noise wₖ(t), unknown complex scalar path attenuation bₗₖ, and channel phase ϕₗₖ, using the given corresponding probability density functions.

STEP 3: Generate rₗₖ using Equation (8).

STEP 4: Define trial initial position (p_{x,init}, p_{y,init}) as the center position, e.g., (p_{x,init}=5, p_{y,init}5).

STEP 5: Define a sufficient number of iterations (e.g., iᵢₜₑᵣₐₜᵢₒₙ=10,000) for the ith trial search run.

STEP 6: Generate a new position (p_{x,new}, p_{y,new}) with Gaussian distributions: p_{x,new}˜N(p_{x,init}=5,\sqrt{p_{x,init}=5}) and p_{y,new}˜N(p_{y,init}=5,\sqrt{p_{y,init}=5}).

STEP 7: Compute μ₁(p₀) and μ₂(p₀) using Equation (4).

STEP 8: Compute A₁ₖ and A₂ₖ using Equation (9).

STEP 9: Compute V₁ₖ and V₂ₖ using Equation (15).

STEP 10: Compute Qₖ using Equation (16), and find the max eigenvalue of the Qₖ matrix.

STEP 11: Compute a new cost function Lᵤₛ(p)_{new}.

STEP 12: If Lᵤₛ(p)_{new}>Lᵤₛ(p)ᵢₙᵢₜ, then update (p_{x,init}, p_{y,init}) as (p_{x,new}, p_{y,new}). Also update the cost function with the latest value. Else, do not update position vector and cost function value. Go to STEP 6 until the iteration is complete for each trial.

STEP 13: Find the position estimate \hat{ }p(i) that gives the final value of Lᵤₛ(p)_{new} at the ith trial.

STEP 14: Increase i to i=i+1. Go to STEP 2 with Lᵤₛ(p)ᵢₙᵢₜ=Lᵤₛ(p)_{new} and (p_{x,init}, p_{y,init})=(p_{x,new}, p_{y,new}) if i≤iₜₒₜₐₗ. Else stop.

STEP 15: Compute the distance between the last trial position estimate \hat{ }p(iₜₒₜₐₗ) and the true position p₀.

Table 1 lists an example of computational complexity and running time using the Precision 5820 Tower workstation and MATLAB for the existing grid search, random memoryless search, and random memory search, when the scenarios in FIGS. 1 and 2 are used with SNR=20 dB, K=10 interceptions, L=2 RX antennas, and Nₑₓₚ=10 trials. The iᵣₘₛ and iᵣₘₗₛ denote the number of randomly generated hypothetical vectors per trial until the algorithm converges for random memory and random memoryless search, respectively. For the existing grid search, the grid size is 0.06 km with Nₓ=N_{y}=167 and N_{grid}=Nₓ×N_{y}=27,889. Observe from Table 1 that the random memory search is 1.84 times and 2.22 times faster than the random memoryless search and the grid search with grid size 0.06 km, respectively. Another grid size 0.012 km increases the computation run time 27 times that of the proposed random memory search. Furthermore, the random memory search is greater than 8,025 times faster than the grid search of grid size=0.001 km.

TABLE 1
Algorithm comparison based on computational complexity
[SNR = 20 dB, Nₑₓₚ = 10 trials]

| | Random Memory | Random Memory- | |
|---|---|---|---|
| | Search | less Search | 2D Grid |
| Complexity | (Nₑₓₚ × iᵣₘₛ)[ | (Nₑₓₚ × iᵣₘₗₛ)[ | (Nₑₓₚ × N_{grid}) |
| | 2L + K(2L)] | 2L + K(2L)] | [2L + K(2L)] |
| Running | 38.37 s | 70.74 s | 85.54 s (Grid |
| Time (s) | | | Size 0.06 km) |
| | | | 1038.00 s (Grid |
| | | | Size 0.012 km) |

Table 2 lists examples of the RMSE values for the existing grid search, random memoryless search, and random memory search when the same scenarios in FIGS. 1 and 2 are used with the same parameters used for Table 1, where the grid size was 0.06 km or 0.012 km for the grid search. The grid size of the 0.001 km case could not be included because it takes more than one month of simulation time, even for one trial and one SNR value.

TABLE 2
Algorithm comparison based on RMSE values of search methods

| | Random Memory | Random Memory- | |
|---|---|---|---|
| SNR (dB) | Search (m) | less Search (m) | 2D Grid (m) |
| 20 | 105.74 | 121.04 | 104.90 |
| 30 | 36.46 | 68.64 | 31.60 |
| 40 | 11.29 | 59.74 | 8.97 (Grid |
| | | | Size 0.06 km) |
| | | | 4.00 (Grid |
| | | | Size 0.012 km) |

Observe from Table 2 that the random memory search, the random memoryless search, and the grid search with grid size 0.06 km show a similar RMSE resolution. The quality of the random memory search and the random memoryless search over the grid search is not degraded, although the search time can be significantly reduced, as indicated in Table 1.

To improve the performance further, the inventors contemplate using chirp RX processing with a finite number of FMx antennas. This approach requires a time-dependent RX frequency at each sample time. For the case without an RX chirp, L=2 number of RX frequencies are created using L=2 number of antennas (i.e., main RX antenna and one FMx antenna). For the chirp case, multiple sample time-dependent RX frequencies are created, e.g., a different RX frequency at each sample time, by switching from an FMx antenna to another FMx antenna in a set of (N−1) FMx antennas. If N samples are taken per interception interval, then it is desirable to employ N−1 number of FMx antennas and one main antenna at the RX side for each group l=1, . . . , L. Here, l represents the RX group index for the chirp case, whereas l represents the RX frequency index for the no-chirp case. Each group consists of n=1, N number of different sample time-dependent frequencies. Here, at the first sample time n=1, the RX frequency is generated via the main RX antenna, and at sample time n, 2≤n≤N, the RX frequency is generated via the nth FMx antenna, Hence, L(N−1) number of FMx antennas are necessary. If a millimeter wave is used by the EMI TX, then the wavelength is a few millimeters, and hence, (L=2)(N−1)=254 FMx antennas can be placed at one RX unit in an area less than 10×10 (cm×cm), assuming a wavelength separation between adjacent antenna elements.

The nth element of a diagonal Doppler shift matrix in Equation (9) is rewritten for the chip case as Equation (34), where l=1, L, n=1, N, and μₗₖ(p₀) denotes the normalized Doppler frequency fraction in Equation (4). Hence, different Doppler frequency effects can be created at each sampling time and can be applicable for the proposed method. Note again that the proposed method does not measure Doppler frequency as was done in [31] but rather uses only the received samples.

Accordingly, it can be seen that the present disclosure provides a system for determining a location of an emitter. A system according to the present disclosure generally comprises a single mobile frame configured for movement relative to the emitter (which can emit a known emitter signal (e.g., SAR application) or an unknown emitter signal (e.g., military reconnaissance application). For example, the frame can be an air frame of a SAR aircraft or reconnaissance aircraft, the body of a satellite, a ground vehicle chassis, or a water vessel, etc.

As shown in FIG. 2-4, the system herein comprises a main receiver supported on the mobile frame at a first location for movement with the mobile frame relative to the emitter and a frequency mixing antenna supported on the mobile frame at a second location for movement with the mobile frame and the main receiver relative to the emitter. In certain embodiments, each frequency mixing antenna comprises a frequency-mixing intelligent reflecting surface antenna, but conventional frequency-mixing antennas also work for this application at significantly reduced cost and so may be preferred. The second location of the frequency mixing antenna is spaced apart from the first location of the main receiver on the common support frame by a relatively small distance (e.g., less than 10 m). As shown in FIG. 3, the frequency mixing antenna is configured to receive an emitter signal from the emitter at the second location and output a frequency-mixed signal (arrow pointing rightward and downward toward main receiver). The main receiver is configured to receive the emitter signal directly at the first location and also to receive the frequency-mixed signal.

As explained above, this system enables localization of the emitter with only one mobile frame because the main receiver receives two Doppler frequencies at offset locations. The first Doppler frequency is derivable from the direct emitter signal, and the second Doppler frequency is derivable from the frequency-mixed signal. Accordingly, the localization methods of the prior art that rely on two Doppler frequencies to establish emitter location can be adapted for use with the above described single-frame localization system.

In an exemplary embodiment, the system further comprises a processor connected to the main receiver and configured to determine the first Doppler frequency and the second Doppler frequency from the direct emitter signal and the frequency-mixed signal, respectively. The processor can be adapted use any suitable multi-Doppler frequency localization method to determine the location of the emitter in a two-dimensional grid or a three-dimensional space. In an exemplary embodiment, the processor is configured to determine the location of the emitter based on the first Doppler frequency and the second Doppler frequency using a direct position determination approach as described above and adapted from [30]. In certain embodiments, the processor is configured to use one of a random memoryless search algorithm or a random memory search algorithm as described above to reduce the grid search computation time for a defined search area. In one or more embodiments, the processor is configured to execute chirp RX processing techniques as described above to further improve localization performance.

The processor mentioned above may reside in a computer including a variety of computer hardware, including memory for storing processor-executable instructions. In general, the processor is configured to execute the programs stored in memory for carrying out the above functions. Components of the programs may reside at various times in different storage components of a computing device, and are executed by the processor of the device.

This disclosure is not limited to any particular computing environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A system for determining a location of an emitter, the system comprising:
a mobile frame configured for movement relative to the emitter;
a main receiver supported on the mobile frame at a first location for movement with the mobile frame relative to the emitter; and
a frequency mixing antenna supported on the mobile frame at a second location for movement with the mobile frame and the main receiver relative to the emitter, the second location being spaced apart from the first location;
wherein the frequency mixing antenna is configured to receive an emitter signal from the emitter at the second location and output a frequency-mixed signal; and
wherein the main receiver is configured to receive the emitter signal at the first location and receive the frequency-mixed signal.

2. The system of claim 1, wherein a first Doppler frequency is derivable from the emitter signal received by the main receiver and a second Doppler frequency different than the first Doppler frequency is derivable from the frequency-mixed signal.

3. The system of claim 2, further comprising a processor connected to the main receiver and configured to determine the first Doppler frequency and the second Doppler frequency.

4. The system of claim 3, wherein the processor is configured to determine the location of the emitter based on the first Doppler frequency and the second Doppler frequency using a direct position determination approach.

5. The system of claim 3, wherein the processor is configured to use one of a random memoryless search algorithm or a random memory search algorithm to reduce the grid search computation time for a defined search area.

6. The system of claim 3, wherein the processor is configured to execute chirp RX processing techniques to improve localization performance.

7. The system of claim 1, wherein the first location is spaced apart from the second location by a distance of less than 10 m.
